(19) United States
(12) Patent Application Publication
(10) Pub. No.: US 2010/0253178 A1
(43) Pub. Date: Oct. 7, 2010

(54) PERMANENT-MAGNET SYNCHRONOUS MOTOR

(76) Inventors: Takayuki Koyama, Hitachi (JP); Hiroshi Kanazawa, Hitachiota (JP); Shoichi Kawamata, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/741,038

(22) PCT Filed: Dec. 25, 2008
(86) PCT No.: PCT/JP2008/003951

§ 371 Date: May 3, 2010

(30) Foreign Application Priority Data
Dec. 27, 2007 (JP) 2007-335500

(51) Int. Cl. H02K 1/18; H02K 1/12

(52) U.S. Cl. 310/216.113; 310/257

(57) ABSTRACT

The present invention can achieve a highly efficient permanent-magnet synchronous motor that can obtain output in a high-speed area without prolonging the axis of the permanent-magnet synchronous motor.

The present invention provides a highly efficient permanent-magnet synchronous motor that can obtain output in a high-speed area without prolonging the axis of the permanent-magnet synchronous motor, in which stator magnetic poles are formed by dividing a magnetic pole in each phase into a plurality of parts and placing them in a circumferential direction with respect to a rotational axis, at least one divided stator magnetic pole being made movable in the circumferential direction with respect to the rotational axis, and the phase of the movable stator is controlled.

### FIELD OF THE INVENTION

The present invention relates to a permanent-magnet synchronous motor that is formed with a stator formed by a plurality of divided stator magnetic poles and with a rotor having permanent magnets.

### BACKGROUND OF THE INVENTION

Since, in a conventional permanent-magnet synchronous motor, counter electromotive force by a magnet increases as the number of revolutions increases, if a power source is a battery or the like, driving in a high rotational speed area has been difficult due to a limitation of a power supply voltage. As a driving method by which a permanent-magnet synchronous motor is driven in a high rotational speed area, there is field weakening control in which a magnetic flux is equivalently weakened by a current. Since a current that does not contribute torque must have flowed, however, efficiency has been lowered.

As a method that solves these problems, Patent Document 1 discloses a method in which mechanical field weakening is performed by dividing the stator into at least two stators in a direction orthogonal to a rotational axis, making at least one stator of the divided stators operable as a movable stator, and phase-controlling the movable stator, so as to realize high-speed rotation of a permanent-magnet synchronous motor.

Patent Document 1: Japanese Patent Laid-open No. 2005-160278

### SUMMARY OF THE INVENTION

In the above prior art, however, a coil end is preset at each end in the rotational axis direction of the permanent-magnet synchronous motor, in which the stator is divided, so the number of coil ends is increased when compared with the number of coils ends before the division. Accordingly, there has been a problem in that the axial length of the permanent-magnet synchronous motor is increased. Furthermore, from the viewpoint of an insulation property, an air layer or the like needs to be provided between each two coil ends, further increasing the axial length. Another problem is that copper loss, which occurs at the coil ends, increases and thereby efficiency is lowered.

The present invention is characterized in that a magnetic pole in each phase is divided into a plurality of stator magnetic poles and placed in a circumferential direction with respect to a rotational axis, and at least one divided stator magnetic pole is made movable in the circumferential direction with respect to the rotational axis.

According to the present invention, it becomes possible to perform mechanical field weakening without having to increase the axial length of a permanent-magnet synchronous motor, and thereby the motor can be driven with counter electromotive force lowered in a high-speed area, so the need for a field weakening current is eliminated, increasing efficiency in the high-speed area.

### BRIEF DESCRIPTION OF THE DRAWINGS

FIG. 1 is a perspective view of the structure of a motor in a first embodiment of the present invention.

FIG. 2 is a part view showing parts constituting a stator magnetic pole in the present invention.

FIG. 3 is divided views of the stator magnetic pole in the present invention.

FIG. 4 is a perspective view of the stator magnetic pole for one phase in the present invention.

FIG. 5 is a perspective view of the structure of the motor in the first embodiment of the present invention when the electric field is weakened.

FIG. 6 is a perspective view of the stator magnetic pole for one phase in the present invention when an electric field is weakened.

FIG. 7 is a perspective view of the structure of a motor in a second embodiment of the present invention.

FIG. 8 is a part view showing parts constituting a stator magnetic pole in the present invention.

FIG. 9 is a perspective view of the stator magnetic pole for one phase in the present invention.

FIG. 10 is a drawing showing the motor in the second embodiment of the present invention from a rotational axis direction.

FIG. 11 is a drawing showing the motor in the second embodiment of the present invention from the rotational axis direction when the electric field is weakened.

FIG. 12 is a perspective view of the structure of a motor in a third embodiment of the present invention.

FIG. 13 is a part view showing parts constituting a stator magnetic pole in the present invention.

FIG. 14 is a perspective view of the stator magnetic pole for one phase in the present invention.

FIG. 15 is a perspective view of the structure of the motor in the third embodiment of the present invention when the electric field is weakened.

FIG. 16 is a perspective view of the stator magnetic pole for one phase in the present invention when the electric field is weakened.

FIG. 17 is a drawing showing a field weakening method in the present invention.

FIG. 18 is a chart representing the relation between the number of revolutions and torque of the motor in the present invention.

FIG. 19 is drawing showing the relation between counter electromotive force generated at a moving stator and counter electromotive force generated at a stator.

### DESCRIPTION OF THE PREFERRED EMBODIMENTS

In a permanent-magnet synchronous motor having a stator in which a magnetic pole having an N pole and an S pole is formed in a circumferential direction with respect to a rotational axis, a rotor disposed on an inner diameter side of a yoke disposed in a radial direction of the stator, the rotor having permanent magnets placed in the circumferential direction with a slight spacing left between the rotor and the stator, and coils in a plurality of phases, which are disposed in the stator, the present invention is characterized in that the magnetic pole is divided into a plurality of magnetic poles in a direction perpendicular to the circumferential direction and placed, and a divided magnetic pole can be moved in the circumferential direction with respect to the rotational axis. In this case, the phases of the divided magnetic poles have a Phase difference.

Incidentally, the permanent-magnet synchronous motor according to the present invention is characterized in that the stator and the rotor have substantially the same magnetic pole pitch.

It is preferable to dispose the magnetic pole of the stator in each phase so that the magnetic pole becomes independent in the circumferential direction. It is also preferable to magnetically divide the stator in a direction perpendicular to the circumferential direction.

Furthermore, more preferable is a case in which the magnetic pole of the stator is divided into two magnetic poles along the axial direction and one of the divided magnetic poles is movable in the circumferential direction.

By contrast, the effects of the present invention can also be achieved by independently disposing, in the axial direction, the divided magnetic pole of the stator in each phase.

Specifically, the stator of the permanent-magnet synchronous motor according to the present invention is characterized in that the stator has magnetic poles in a plurality of phases, which are divided in a direction perpendicular to the circumferential direction, each of the divided magnetic poles has an arcuate stator iron core that has a plurality of claw magnetic poles extending in the axial direction and also has a coil wound in an elliptical shape, and a divided magnetic pole is movable along the circumferential direction.

In addition, the permanent-magnet synchronous motor according to the present invention is also characterized in that the stator has a piezoelectric device and linking members that link the magnetic poles, which are divided in a direction perpendicular to the circumferential direction, and a movable state of a magnetic pole is controlled by using the piezoelectric device according to an operation situation of the permanent-magnet synchronous motor.

More specifically, in a motor that has a stator formed by oppositely disposing a first claw magnetic pole, which includes a radial yoke, a plurality of claws disposed on an inner diameter side of the radial yoke, and an outer circumferential yoke extending on an outer diameter side of the radial yoke, and a second claw magnetic pole, which includes a radial yoke, a plurality of claws disposed on an inner diameter side of the radial yoke, and an outer circumferential yoke extending on an outer diameter side of the radial yoke, and by mutually engaging a first claw and a second claw, and also has a coil disposed between the first claw and the second claw, and a rotor that is placed on an inner diameter side of the stator in a circumferential direction with a spacing left, the permanent-magnet synchronous motor according to the present invention is characterized in that the stator is movable along the circumferential direction.

A plurality of stators is preferably stacked along the rotational axis.

A best mode for carrying out the present invention will be described according to the drawings.

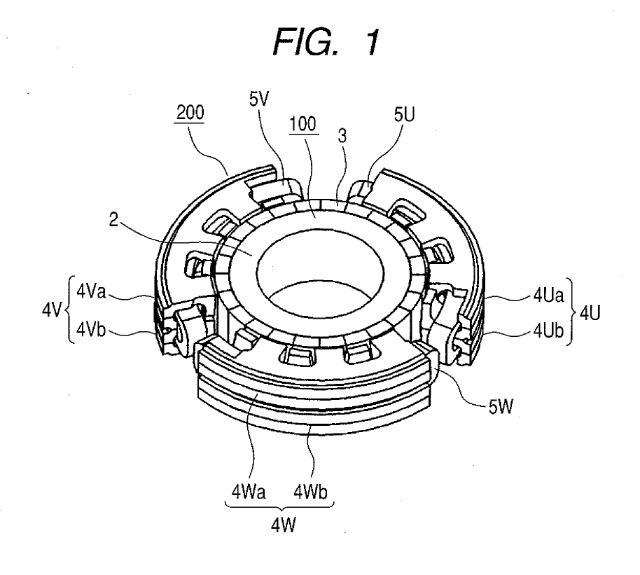

FIG. 1 shows a permanent-magnet synchronous motor that is the first embodiment of the present invention, in which stator magnetic poles in the three phases are disposed in the rotational direction so that the stator magnetic poles become magnetically independent. The number of poles in the rotor is 24. The structure will be first described. A shaft (not shown) is provided at the center of the rotor 100. A rotor yoke 2 is provided along the outer circumference of the shaft. Permanent magnets 3 are provided along the outer circumference of the rotor yoke 2. The permanent magnets 3 are magnetically attached to the 24 poles. Inherently, a motor needs a supporting mechanism such as a case or bearing, but it is omitted in this drawing. Next, the stator 200 will be described. As for the stator magnetic poles, three magnetic poles are disposed along the outer circumference of the permanent magnets 3 of the rotor with a slight spacing left so that Phase differences in three phases are obtained. Three-phase stator magnetic poles, which are a U-phase magnetic pole 4U, a V-phase magnetic pole 4V, and a W-phase magnetic pole 4W, are disposed so that they substantially overlap the permanent magnets 3 of the rotor. A stator coil is disposed at the center of the magnetic pole in each phase; a U-phase coil is indicated by 5U, a V-phase coil is indicated by 5V, and a W-phase coil is indicated by 5W. Furthermore, the coil in each phase has a U-shaped coil end at the end of the stator magnetic pole. The coil is extracted from the axial direction of the coil end, and is connected to a battery through an inverter. In this stator structure, each stator magnetic pole is disposed along the outer circumference of the rotor through linking member (not shown) with a Phase difference of an electrical angle of 120 degrees. This linking member may have any structure if it can mechanically fix the stator magnetic poles in each phase. The linking member is preferably made of a non-magnetic metal. Furthermore, after being linked, the stator magnetic poles may be molded in a cylindrical shape.

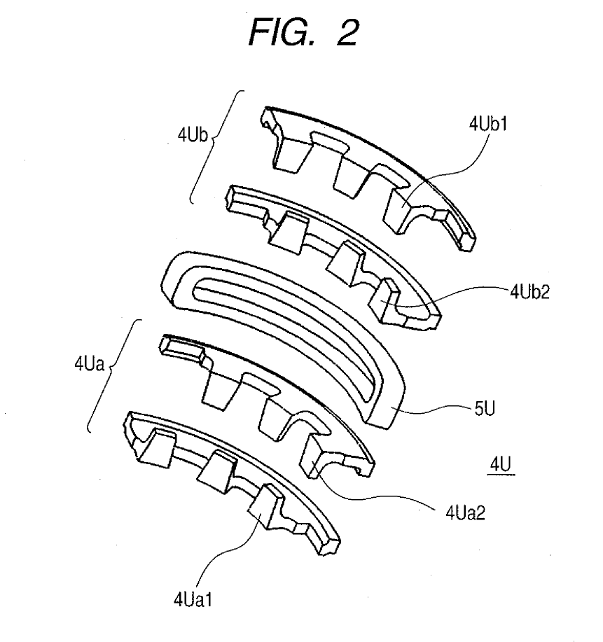

The stator magnetic pole 4U, which has been described by using FIG. 1, will be described in detail by using FIG. 2. Description of 4V and 4W in the other phases will be omitted because they have the same structure as the U-phase stator magnetic pole 4U. As described earlier, the U-phase magnetic pole 40 is structured by five parts. The stator magnetic pole 4U includes two magnetic pole strings, which are 4Ua and 4Ub. For example, the magnetic pole string 4Ua includes magnetic pole teeth 4Ua1 that are disposed toward the inner circumference side and magnetic pole teeth 4Ua2 that are disposed toward the outside, and is structured so that a coil on one side of the U-phase coil 5U is caught between the centers of 4Ua1 and 4Ua2. Furthermore, the other coil of the U-phase coil 5U is caught between the centers of 4Ub1 and 4Ub2, which constitute the other magnetic pole string 4Ub. Although not shown, a lead wire of the U-phase coil 5U is extracted from the U-shaped coil end, which is not caught between the magnetic poles.

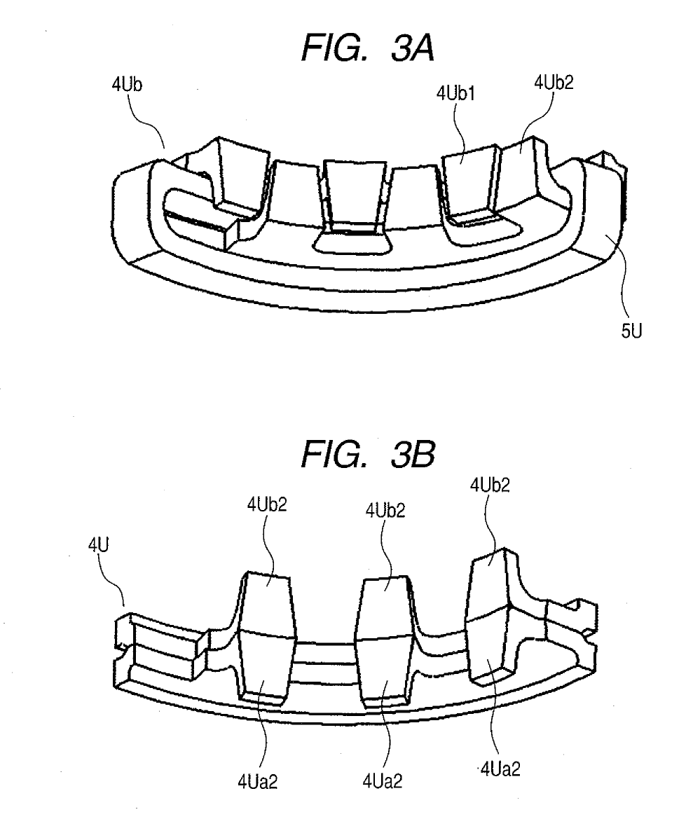

FIG. 3(a) shows a structure in which the U-phase coil 5U is caught into the magnetic pole string 4Ub of the U-phase magnetic pole described above. The magnetic pole of the magnetic pole string 4Ua is disposed at the coil on the near side in the drawing sheet. FIG. 3(b) shows the magnetic pole, at the center of the coil, on which the U-phase coil 5U is wound. The U-phase coil 5U may be directly wound around the outward magnetic pole teeth 4Ua2 and 4Ub2 shown on the drawing. Alternately, a coil formed in a horseshoe shape may be disposed. It is also possible to integrally form 4Ua2 and 4Ub2.

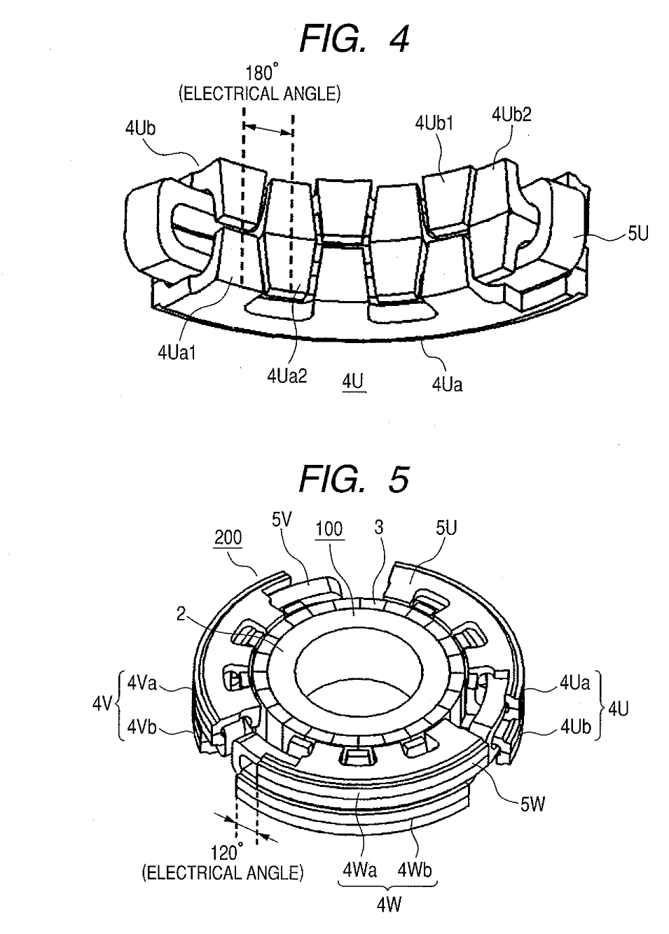

FIG. 4 is a completion diagram of the U-phase magnetic pole 4U. As described above, the U-phase coil 5U is disposed at the centers of the two magnetic pole strings. As seen from the drawing, the magnetic pole teeth constituting the magnetic pole string 4Ua have the same shape. The magnetic pole teeth constituting the other magnetic pole string 4Ub also have almost the same shape. As shown in the drawing, the U-phase magnetic pole 4U is structured so that a phase difference between the magnetic pole teeth 4Ua2 and 4Ub2, which are outwardly formed, and the magnetic pole teeth 4Ua1 and 4Ub1, which are inwardly formed, is equivalent to an electrical angle of 180 degrees. The positional relationship between the magnetic pole string 4Ua and the magnetic pole string 4Ub shown in FIG. 4 is such that a magnetic flux that interlinks the coil in the magnetic pole string 4Ua and a magnetic flux that interlinks the coil in the magnetic pole string 4Ub have the same phase. Accordingly, when the rotor rotates, the phases of the counter electromotive forces generated in the coils in the magnetic pole strings 4Ua and 4Ub also become the same. So, the positional relationship between the magnetic pole string 4Ua and the magnetic pole string 4Ub shown in FIG. 4 is such that the coil 5U generates the maximum counter electromotive force.

In this embodiment, the magnetic pole string 4Ua is structured so that it is movable in the circumferential direction with respect to the rotational axis, and the magnetic pole string 4Ub is fixed to a case (not shown). In the other phases as well, the magnetic pole strings 4Va and 4Wa are structured so that they become movable in the circumferential direction with respect to the rotational axis, and the magnetic pole strings 4Vb and 4Wb are fixed to the case. FIG. 5 is an external view in a case in which the magnetic pole strings 4Ua, 4Va, and 4Wa are shifted in the circumferential direction by an electrical angle of 120 degrees. The magnetic pole strings 4Ua, 4Va, and 4Wa are shifted in the same direction. The magnetic pole strings 4Ua, 4Va, and 4Wa will be referred to below as the movable stators.

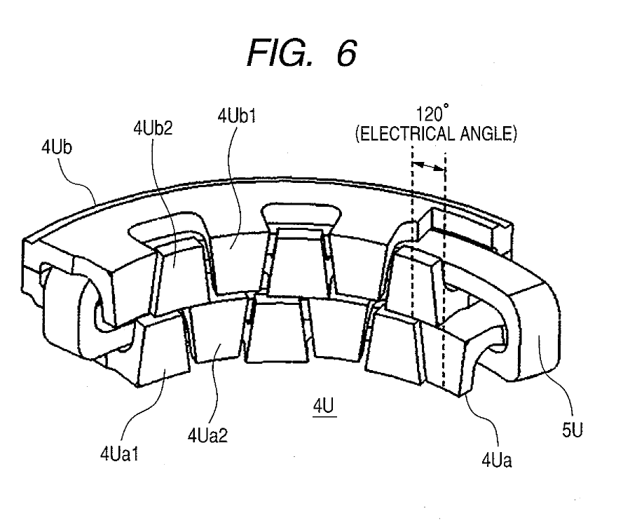

FIG. 6 is an external view of the U-phase magnetic pole 4U in a case in which the movable stator 4Ua is moved in the circumferential direction by an electrical angle of 120 degrees. The movable stator 4Ua is moved so that a difference in phase between the magnetic pole teeth 4Ua2 and 4Ub2, which are outwardly formed, becomes an electrical angle of 120 degrees. Accordingly, a Phase difference between the magnetic flux, which interlinks the coil in the movable stator 4Ua, and the counter electromotive force generated in the coil 4Ub becomes 120 degrees. As a result, the magnitude of the counter electromotive force generated in the coil 5U becomes half its maximum counter electromotive force. When the same operation is performed on the V-phase magnetic pole 4V and W-phase magnetic pole 4W, the magnitudes of the counter electromotive forces generated in the coils 5V and 5W become half their maximum counter electromotive forces. That is, the counter electromotive forces can be suppressed in the high-speed rotation area without the need for a field weakening current. When the amount by which the movable stator 4Ua is moved is adjusted, it is also possible to adjust an amount by which the counter electromotive force is suppressed or to arbitrary set the counter electromotive force. Then, even if a limited inverter or battery voltage is used, the permanent-magnet synchronous motor according to this embodiment can be driven in a high-speed rotation area. Furthermore, since a field weakening current is not required, a loss due to the field weakening current is not generated, resulting in a loss reduction. In this structure, there is no coil end in the rotational axis direction, so the axial length can also be shortened.

Next, another embodiment of the permanent-magnet synchronous motor according to the present invention will be described. The other embodiment is the same as the embodiment described above except for the following.

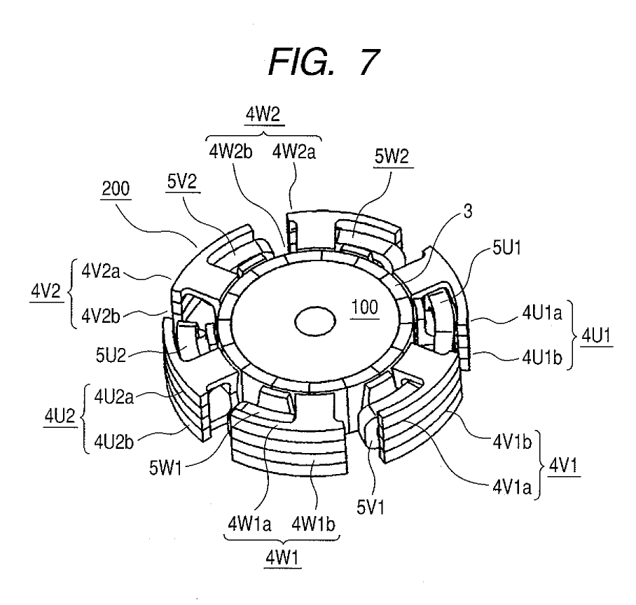

FIG. 7 is a drawing showing one embodiment of the permanent-magnet synchronous motor according to the present invention. The number of poles of the rotor is 16. The structure of the rotor in other aspects is the same as in FIG. 1. Six stator magnetic poles are disposed along the outer circumference of the permanent magnets 3 of the rotor with a slight spacing left so that Phase differences in three phases are obtained. Three-phase stator magnetic poles, which are U-phase magnetic poles 4U1 and 4U2, V-phase magnetic poles 4V1 and 4V2, and W-phase magnetic poles 4W1 and 4W2, are disposed so that they substantially overlap the permanent magnets 3 of the rotor. A stator coil is disposed at the center of the magnetic pole in each phase; a U-phase coil 5U1 is placed in the U-phase magnetic pole 4U1, a U-phase coil 5U2 is placed in the U-phase magnetic pole 4U2, a V-phase coil 5V1 is placed in the V-phase magnetic pole 4V1, a V-phase coil 5V2 is placed in the V-phase magnetic pole 4V2, a W-phase coil 5W1 is placed in the W-phase magnetic pole 4W1, and a W-phase coil 5W2 is placed in the W-phase magnetic pole 4W2. Each coil in each phase has a U-shaped coil end at the end of the stator magnetic pole, and is connected from the coil end to a lead wire. Furthermore, three-phase windings are formed by mutually connecting the U-phase coil 5U1 and the U-phase coil 5U2 in series, mutually connecting the V-phase coil 5V1 and the V-phase coil 5V2 in series, and by mutually connecting the W-phase coil 5W1 and the W-phase coil 5W2 in series. The U-phase magnetic pole 4U1, V-phase magnetic pole 4V1, and W-phase magnetic pole 4W1 are fixed to a case (not shown), and the U-phase magnetic pole 4U2, V-phase magnetic pole 4V2, and W-phase magnetic pole 4W2 are structured so that they become movable in the circumferential direction with respect to the rotational axis.

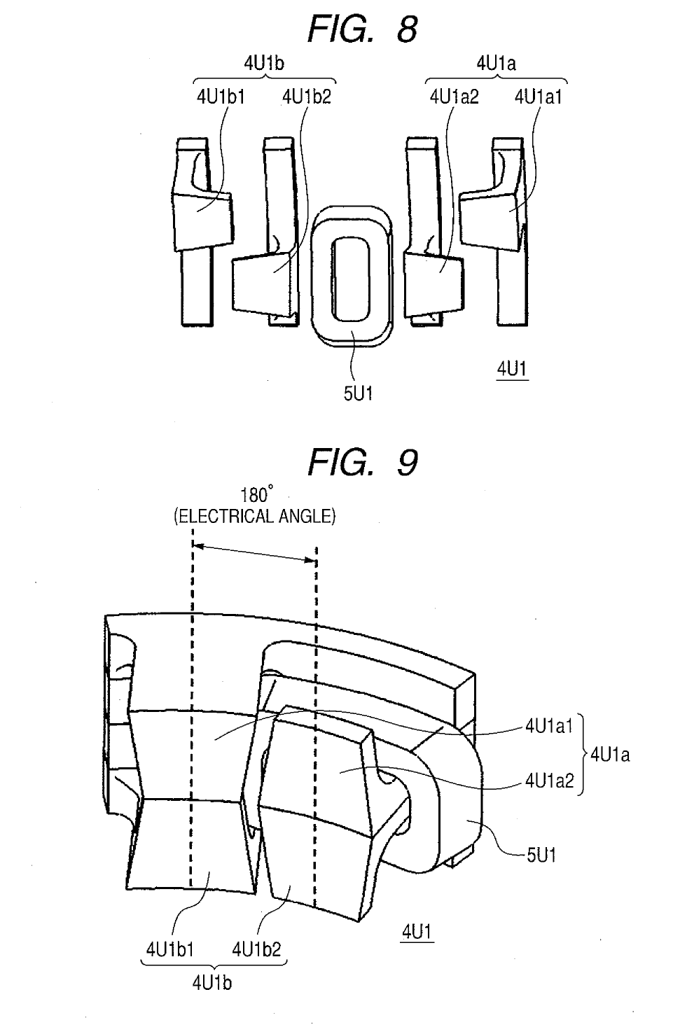

FIG. 8 is an exploded view of the stator magnetic pole 4U1 illustrated in FIG. 7. Description of the other stator magnetic poles 4U2, 4V1, 4V2, 4W1, and 4W2 will be omitted because they have the same structure as the U-phase stator magnetic pole 4U1. As described earlier, the U-phase magnetic pole 4U is structured by five parts. The stator magnetic pole 4U1 includes two magnetic pole strings, which are 4U1a and 4U1b. For example, the magnetic pole string 4U1a includes magnetic pole teeth 4Ua1 that are disposed toward the inner circumference side and magnetic pole teeth 4Ua2 that are disposed toward the outside, and is structured so that a coil on one side of the U-phase coil 5U is caught between the centers of 4U1a1 and 4U1a2. Furthermore, the other coil of the U-phase coil 5U is caught between the centers of 4U1b1 and 4U1b2, which constitute the other magnetic pole string 4U1b.

FIG. 9 is an external view of the stator magnetic pole 4U1. As described above, the U-phase coil 5U1 is disposed at the centers of the two magnetic pole strings. As shown in the drawing, the stator magnetic pole 4U1 is structured so that a Phase difference between the magnetic pole teeth 4U1a2 and 4U1b2, which are outwardly formed, and the magnetic pole teeth 4U1a1 and 4Ulb1, which are inwardly formed, is equivalent to an electrical angle of 180 degrees.

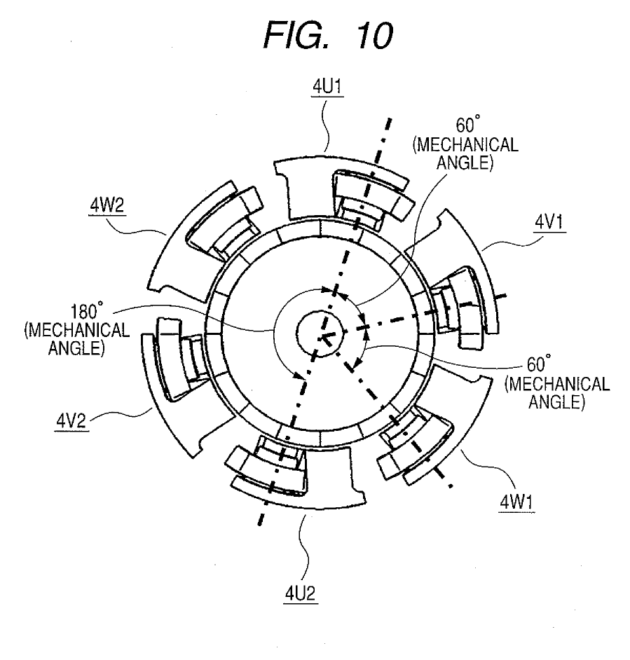

FIG. 10 is a drawing when FIG. 7 is viewed from the rotational axis direction. The three-phase stator magnetic poles, which are U-phase magnetic poles 4U1 and 4U2, V-phase magnetic poles 4V1 and 4V2, and W-phase magnetic poles 4W1 and 4W2, are equally spaced in the circumferential direction with a shift of a mechanical angle of 60 degrees (equivalent to an electrical angle of 120 degrees because there are 20 poles). Accordingly, since the U-phase magnetic poles 4U1 and 4U2 are disposed at positions that are apart from each other by a mechanical angle of 180 degrees, the counter electromotive forces generated in the U-phase coils 5U1 and 5U2 have the same phase. Similarly, the counter electromotive forces generated in the V-phase coils 5V1 and 5V2 have the same phase, and the counter electromotive forces generated in the W-phase coils 5W1 and 5W2 have the same phase. Then, the magnitude of the counter electromotive force developed in U-phase coil formed by interconnecting the U-phase coils 5U1 and 5U2 in series become a maximum in this structure.

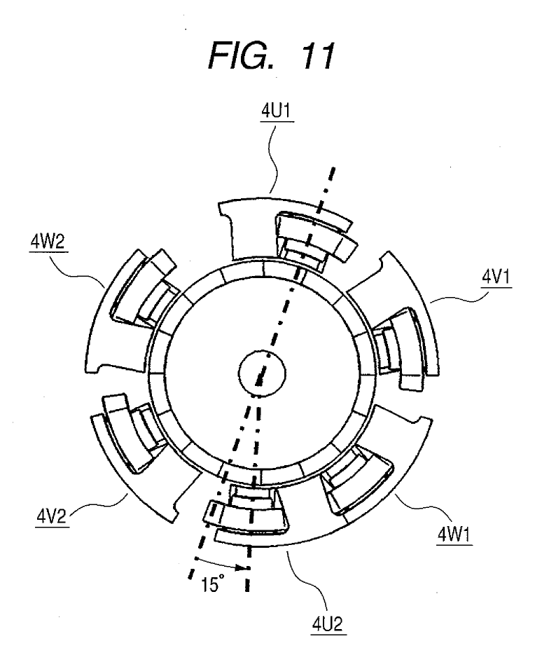

A method of driving a permanent-magnet synchronous motor with this structure in a high rotational speed area will be described below. FIG. 11 shows a structure in which the U-phase magnetic pole 4U2, V-phase magnetic pole 4V2, and W-phase magnetic pole 4W2, which are structured so that they become movable in the circumferential direction with respect to the rotational axis, are each moved by a mechanical angle of 15 degrees in the circumferential direction. Accordingly, the U-phase magnetic poles 4U1 and 4U2 are disposed apart from each other by a mechanical angle of 165 degrees in the circumferential direction, so a Phase difference between the counter electromotive forces generated at these magnetic poles is 120 degrees. Then, the magnitude of the counter electromotive force developed in the U-phase coil, which is formed by interconnecting the U-phase coils 5U1 and 5U2 in series, becomes half its maximum counter electromotive force. Similarly, the magnitudes of the counter electromotive forces developed in the V-phase coil and W-phase coil become half their maximum counter electromotive forces. As described above, as in the embodiment described earlier, the counter electromotive forces can be suppressed in the high-speed rotation area without the need for a field weakening current. In this structure as well, there is no coil end in the rotational axis direction, so the axial length can also be shortened and copper loss, which would otherwise be caused at the coil end, is eliminated, increasing efficiency. That is, the effects of the present invention can be particularly expected in applications where continuous operation is needed at high speed.

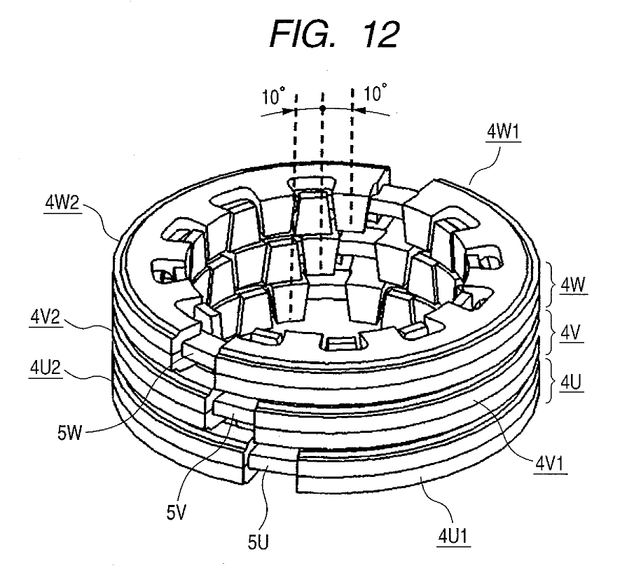

FIG. 12 is a drawing showing one embodiment of the stator in the permanent-magnet synchronous motor according to the present invention. The number of poles in the rotor (not shown) is 24, and the structure of the rotor in other aspects is the same as in FIG. 1. The stator is structured in a plurality of phases by placing a plurality of one-phase stators, each of which has claw magnetic poles, in the axial direction. In this embodiment, a three-phase stator is structured by placing one-phase stators 4U, 4V, and 4W in the axial direction and equally spacing them by a mechanical angle of 10 degrees (equivalent to an electrical angle of 120 degrees). The one-phase stators 4U, 4V, and 4W have the coils 5U, 5V, and 5W, respectively, which are formed by winding a circular ring-shaped electrical conductor by a plurality of turns, forming the stator of the permanent-magnet synchronous motor.

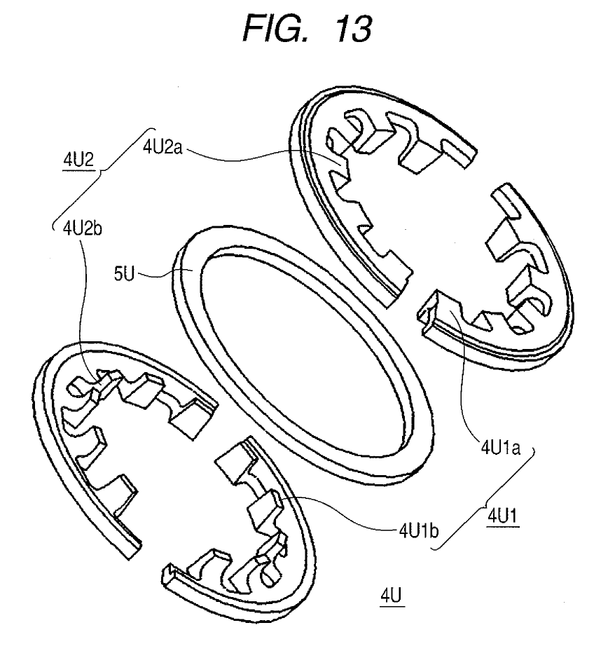

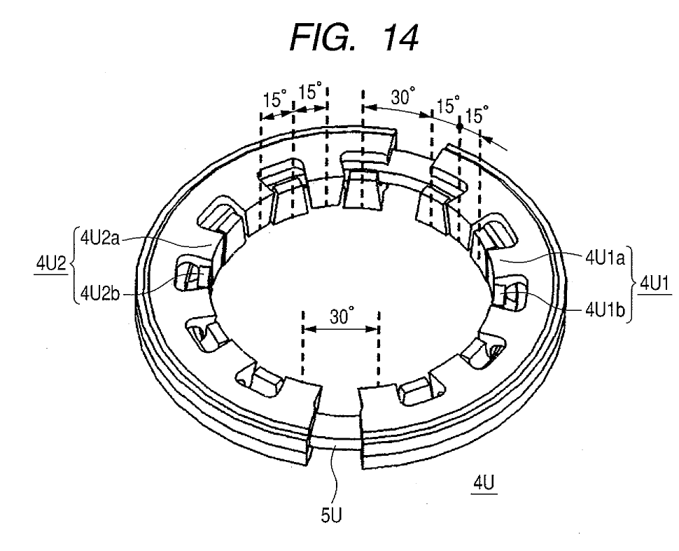

The one-phase stator 4U will be described in detail by using FIGS. 13 and 14. The one-phase stators 4V and 4W also have the same structure. The one-phase stator 4U has a plurality of claw magnetic poles, which are divided in the circumferential direction. In the structure shown in FIG. 13, the one-phase stator 4U has 22 claw magnetic poles, and is formed with two stators 4U1 and 4U2, which are divided in the circumferential direction. The stator 401 is divided into two parts in the axial direction, and has a plurality of claw magnetic poles 4U1a and a plurality of claw magnetic poles 4U1b, which are opposite to magnetic poles 4U1a. Similarly, the stator 4U2 is also divided into two parts in the axial direction, and has a plurality of claw magnetic poles 4U2a and a plurality of claw magnetic poles 4U2b, which are opposite to magnetic poles 4U2a. The claw magnetic pole 4U1a and the claw magnetic pole 4U1b are disposed with a Phase difference of a mechanical angle of 15 degrees (equivalent to an electrical angle of 180 degrees). This relation is also true for the claw magnetic pole 4U2a and the claw magnetic pole 4U2b. The coil 5U is accommodated in the stator 4U in such a way that the coil 5U is caught by the claw magnetic poles 4U1a and the claw magnetic poles 4U1b from the axial direction and caught by the claw magnetic poles 4U2a and the claw magnetic poles 4U2b from the axial direction. The two stators 4U1 and 4U2, which are divided in the circumferential direction, are located with a Phase difference of a mechanical angle of 30 degrees, that is, their phases in terms of the electrical angle are equal. Accordingly, a magnetic flux that interlinks the coil 50 in the stator 4U1 and a magnetic flux that interlinks the coil 5U in the stator 4U2 have the same phase, so the stators 4U1 and 4U2 are located at positions where the coil 5U generates the maximum counter electromotive force.

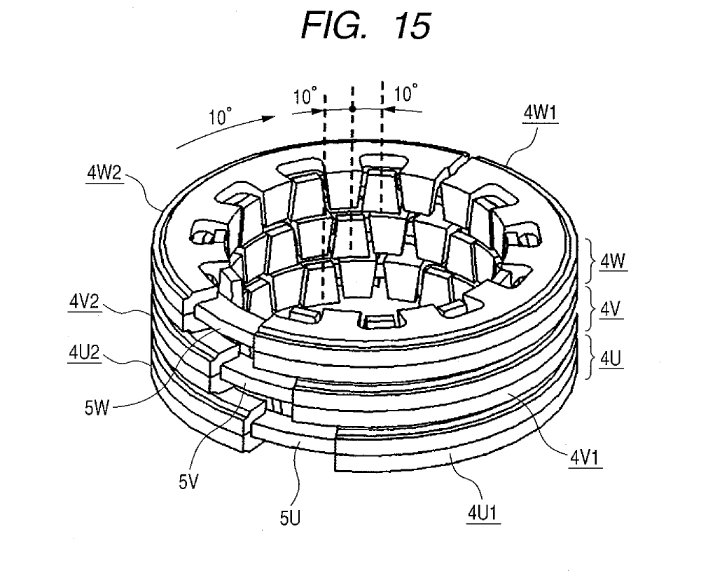

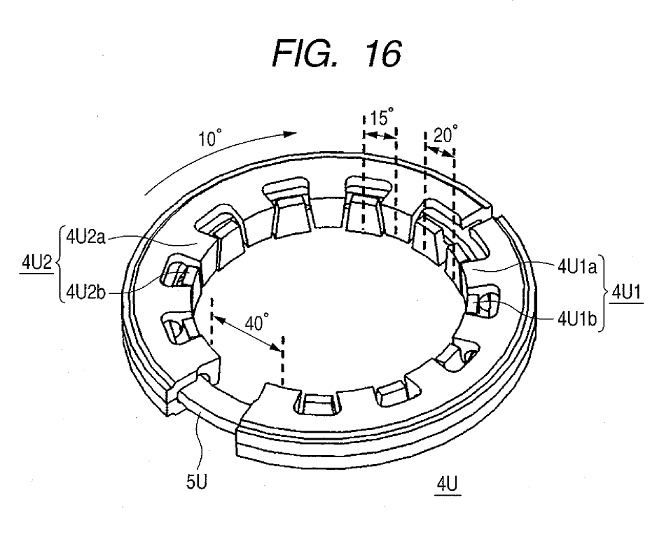

In the stator 4U, the divided stator 4U1 is fixed to a case (not shown), and the divided stator 4U2 is structured so that it becomes movable in the circumferential direction. As with the stators 4V and 4W as well, the divided stators 4V1 and 4W1 are fixed to the case, and the divided stators 4V2 and 4W2 are structured so that they become movable in the circumferential direction. FIGS. 15 and 16 show an exemplary structure in which the movable stators 4U2, 4V2, and 4W2 are moved by a mechanical angle of 10 degrees (equivalent to an electrical angle of 120 degrees) in the circumferential direction. In this case, there is a Phase difference of 120 degrees between the magnetic flux interlinking the coil 5U in the stator 4U1 and the magnetic flux interlinking the coil 5U in the stator 4U2. Accordingly, the magnitude of the counter electromotive force generated in the coil 5U becomes half its maximum counter electromotive force. As described above, as in the embodiment described earlier, the counter electromotive forces can be suppressed in the high-speed rotation area without the need for a field weakening current. In this structure as well, there is no coil end in the rotational axis direction, so the axial length can also be shortened and copper loss, which would otherwise be caused at the coil end, is eliminated, increasing efficiency.

The magnetic poles that have been described so far can be achieved by pressing a dust core. It is also possible to form these magnetic poles by bending an iron plate or by using a sintered material of a magnetic body. Furthermore, it is also possible to achieve these magnetic poles by forming magnetic pole teeth in a ring shape, cutting them into a necessary number of pieces, and combining the cut pieces.

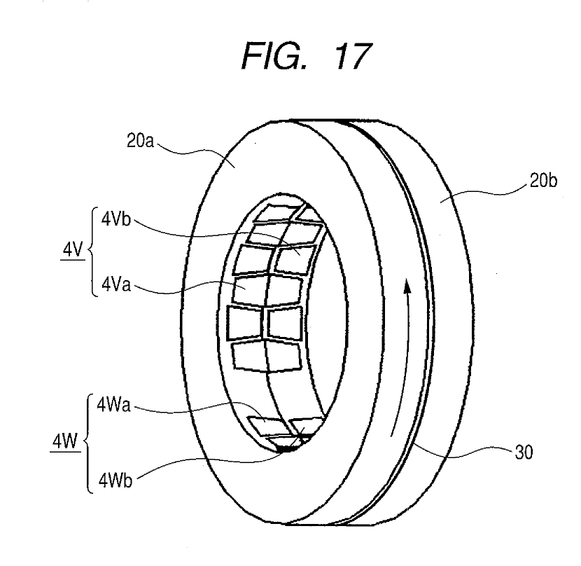

Next, the method of moving the movable stator of the permanent-magnet synchronous motor according to the present invention will be described. FIG. 17 is a drawing in which the stator shown in FIG. 1 is fixed with linking members. The stator magnetic poles 4U, 4V, and 4W are fixed with a Phase difference of an electrical angle of 120 degrees in the circumferential direction by linking members 20a and 20b. In particular, the linking member 20a fixes the magnetic pole string 4Ua, 4Va, and 4Wa, and the linking member 20b fixes the magnetic pole string 4Ub, 4Vb, and 4Wb. Here, the linking member 20a does not come into contact with a housing (not shown) and the linking member 20b, and the linking member 20b is fixed to the housing. In this embodiment, the magnetic pole strings 4Ua, 4Va, and 4Wa are rotated in the circumferential direction, a doughnut-shaped piezoelectric device 30 is provided between the linking member 20a and linking member 20b to mechanically perform field weakening, and the linking member 20a is rotated by the piezoelectric device so as to enable field weakening as described above. While the piezoelectric device is not driven, the linking member 20a is fixed to the linking member 20b due to static torque of the piezoelectric device.

The movable stator of the permanent-magnet synchronous motor may be rotated during the driving of the permanent-magnet synchronous motor or may be rotated during the non-driving of the permanent-magnet synchronous motor. When the movable stator is rotated during the driving, torque needed for the rotation can be minimized by rotating the movable stator in a direction opposite to the rotational direction of the rotor.

Next, the method of controlling the phases of the movable stator of the permanent-magnet synchronous motor according to the present invention will be described in detail. In the present invention, the phase of the movable stator is controlled between a position at which the counter electromotive force is maximized and a position at which the counter electromotive force is minimized, according to the operation state of the motor. Specifically, in a case in which the motor starts from a halted state or is operating at low speed, large torque is needed, so the phase of the movable stator is controlled so that the counter electromotive force is maximized. In a high-speed operation state, the phase of the movable stator is controlled so that a voltage is supplied from a battery to reduce the counter electromotive force. Accordingly, the motor output can be expanded up to a high-speed area. In this case, the Phase difference between the linking member 20a and the linking member 20b is fed back by a sensor (not shown) to control the position of the linking member 20a in the rotational circumferential direction. When predetermined values, which are 0 degree and 120 degrees, are used as the values of the Phase difference between the linking member 20a and the linking member 20b, open loop control is also possible by providing a mechanical stopper.

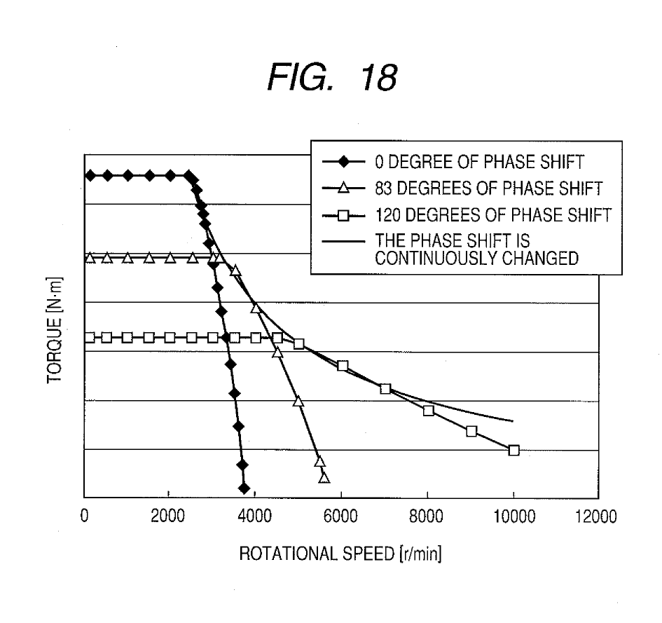

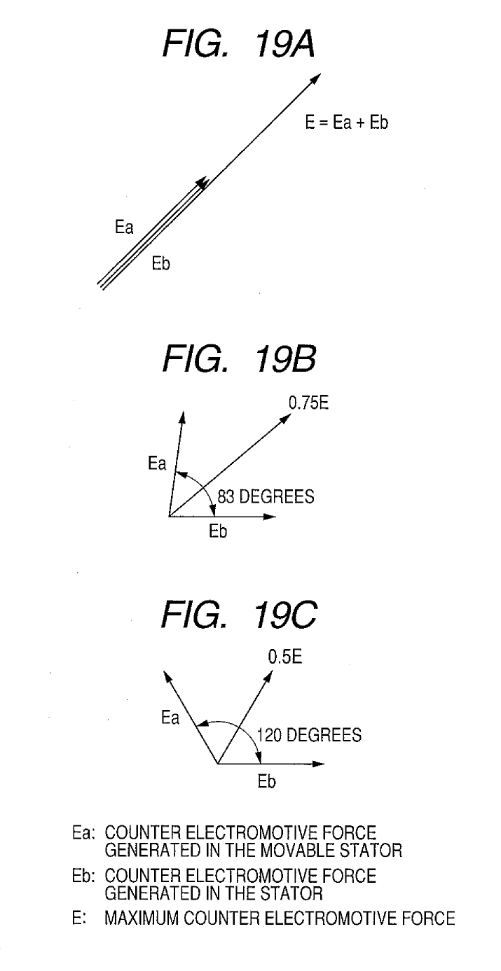

Next, advantages of the present invention will be described. FIG. 18 illustrates the relation between torque by the permanent-magnet synchronous motor according to the present invention and the number of revolutions. The drawing shows cases in which the values of the Phase difference between the movable stator and the stator are 0 degree, 83 degrees, and 120 degrees, assuming that the magnitudes of induced voltages generated in the movable stator and the stator are equal. When the Phase difference between the movable stator and the stator is 0 degree, the Phase difference between the counter electromotive forces generated in the movable stator and the stator is 0, as shown by the vector in FIG. 19(a), so the maximum counter electromotive force is generated. When the Phase difference between the movable stator and the stator is 83 degrees, a counter electromotive force that is 75% of the maximum counter electromotive force is generated, as shown in FIG. 19(b). When the Phase difference between the movable stator and the stator is 120 degrees, a counter electromotive force that is 50% of the maximum counter electromotive force is generated. It can be seen that if the power supply is a battery or the like and thus there is a limitation on the power supply voltage, when the counter electromotive force is reduced according to the present invention, the output range can be expanded up to a high-speed area, as shown in FIG. 18. It is also possible to obtain both large torque in a low-speed area and output in a high-speed area by controlling the Phase difference between the movable stator and the stator according to the number of revolutions. Unlike field weakening by a current, no field weakening current is required, so a loss due to a field weakening current is not generated. Accordingly, the efficiency of the permanent-magnet synchronous motor is increased.

The structure described in Patent Document 1 is available as a method of obtaining output in a high-speed area without the need for a field weakening current in a similar permanent-magnet synchronous motor. In this structure, the stator is divided into at least two stators in a direction orthogonal to the rotational axis, at least one of the divided stators is used as a movable stator, and the phase of the movable stator is controlled to mechanically perform field weakening. However, the structure is problematic in that since the number of coil ends present at ends in the rotational axis direction of the motor, in which the stator is divided, is increased, the axis of the motor is prolonged and thereby copper loss at the coil ends increases. By contrast, with the permanent-magnet synchronous motor according to the present invention, the motor axis can be shortened because there is no coil end in the rotational axis direction, and the problem of an increase in copper loss is eliminated because of a structure in which coil ends can be lessened. That is, the present invention can provide a highly efficient permanent-magnet synchronous motor that can obtain output in a high-speed area without prolonging the axis of the permanent-magnet synchronous motor.

What is claimed is:

1. A permanent-magnet synchronous motor having
a stator in which a magnetic pole having an N pole and an S pole is formed in a circumferential direction with respect to a rotational axis,
a rotor disposed on an inner diameter side of a yoke disposed in a radial direction of the stator, the rotor having permanent magnets placed in the circumferential direction with a slight spacing left between the rotor and the stator, and
coils in a plurality of phases, which are disposed in the stator,
the permanent-magnet synchronous motor being characterized in that:
the magnetic pole is divided into a plurality of magnetic poles; and
a divided magnetic pole is movable in the circumferential direction with respect to the rotational axis.

2. The permanent-magnet synchronous motor according to claim 1, characterized in that the divided magnetic pole of the stator in each phase is disposed so that the divided magnetic pole becomes independent in the circumferential direction.

3. The permanent-magnet synchronous motor according to claim 1, characterized in that the stator is magnetically divided in a direction perpendicular to the circumferential direction.

4. The permanent-magnet synchronous motor according to claim 1, characterized in that the magnetic pole is divided in a direction perpendicular to an axial direction and one divided magnetic pole is movable in the circumferential direction.

5. The permanent-magnet synchronous motor according to claim 2, characterized in that a magnetic pole divided into the direction perpendicular to the circumferential direction is movable in the circumferential direction, and phases of the divided magnetic poles have a Phase difference.

6. The permanent-magnet synchronous motor according to claim 1, characterized in that the divided magnetic pole of the stator in each phase is independently disposed in the axial direction.

7. The permanent-magnet synchronous motor according to claim 1, characterized in that the stator and the rotor have substantially the same magnetic pole pitch.

8. A permanent-magnet synchronous motor, characterized in that:
a stator has magnetic poles, which are divided in a direction perpendicular to a circumferential direction, in a plurality of phases;
each of the divided magnetic poles has an arcuate stator iron core that has a plurality of claw magnetic poles extending in an axial direction and also has a coil wound in an elliptical shape; and
a divided magnetic pole is movable along the circumferential direction.

9. The permanent-magnet synchronous motor according to claim 8, characterized in that the divided magnetic pole is divided in a direction perpendicular to a rotational axis, and one of the divided magnetic poles is movable in the circumferential direction.

10. The permanent-magnet synchronous motor according to claim 8, characterized in that:
the permanent-magnet synchronous motor has a piezoelectric device and linking members that link the magnetic poles, which are divided in a direction perpendicular to the circumferential direction; and
a movable state of the magnetic pole is controlled by using the piezoelectric device according to an operation situation of the permanent-magnet synchronous motor.

11. A permanent-magnet synchronous motor having
a stator formed by oppositely disposing a first claw magnetic pole, which includes a radial yoke, a plurality of claws disposed on an inner diameter side of the radial yoke, and an outer circumferential yoke extending on an outer diameter side of the radial yoke, and a second claw magnetic pole, which includes a radial yoke, a plurality of claws disposed on an inner diameter side of the radial yoke, and an outer circumferential yoke extending on an outer diameter side of the radial yoke, and by mutually engaging a first claw and a second claw,
a coil disposed between the first claw and the second claw, and
a rotor that is placed on an inner diameter side of the stator in a circumferential direction with a spacing left,
the magnetic permanent-magnet synchronous motor being characterized in that the stator is movable along the circumferential direction.

12. The permanent-magnet synchronous motor according to claim 11, characterized in that the stator is magnetically divided in a direction perpendicular to the circumferential direction.

13. The permanent-magnet synchronous motor according to claim 11, characterized in that a plurality of stators are stacked along a rotational axis.
